(19) United States
(12) Patent Application Publication
(10) Pub. No.: US 2006/0221255 A1
(43) Pub. Date: Oct. 5, 2006

(54) Video apparatus

(75) Inventor: Katsuaki Okubo, Oume-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/376,171

(22) Filed: Mar. 16, 2006

(30) Foreign Application Priority Data
Mar. 31, 2005 (JP) 2005-105195

(51) Int. Cl. H04N 5/268

(52) U.S. Cl. 348/706

(57) ABSTRACT

A selector selects a video signal from video signals input via any of a plurality of video input terminals, and outputs the thus-selected video signal. A plurality of video signal detection sections determine whether or not video signals are being supplied from the plurality of video input terminals. When a video signal is newly detected, a plurality of video signal determination sections determine a format of the video signal. A signal processing section performs, on the video signal output from the selector, signal processing in accordance with a result of the determination output from the signal determination sections. When the video signal is newly detected during a period in which no video signal is being supplied to the plurality of video input terminals, control means causes the selector to select the thus-detected video signal.

### CROSS-REFERENCE TO RELATED APPLICATIONS

This application is based upon and claims the benefit of priority from Japanese Patent Application No. 2005-105195, filed on Mar. 31, 2005, the entire contents of which are incorporated herein by reference.

### BACKGROUND

1. Field

One embodiment relates to video apparatus, and, more particularly, to a video apparatus in which display is performed by switching input signals.

2. Description of the Related Art

A television receiver has hitherto been provided as an example of a video apparatus which has a plurality of signal input terminals and which, upon receipt of an input of a new signal to the signal input terminal, displays a video image according to the new signal by switching to the new signal (see, e.g., JP-A-2001-157135).

According to the technique described in the document JP-A-2001-157135, signals input to a first through fourth external input terminals are detected by a signal detection section. Upon detection of input of a new signal, the signal detection section performs display pertaining to this signal in a predetermined display mode.

However, the document JP-A-2001-157135 fails to disclose a method by means of which the signal detection section detects signals input to the first through fourth external input terminals. Therefore, detecting whether a signal is being input may consume excessive time. For instance, when signals input to the first through fourth external input terminals are sequentially switched, detection of whether a signal is being input consumes time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram for describing the configuration of a video apparatus according to a first embodiment;

FIG. 2 is an exemplary block diagram for describing another configuration of a video apparatus according to a second embodiment;

FIG. 3 is an exemplary view illustrating an example OSD;

FIG. 4 is an exemplary view illustrating another example OSD;

FIGS. 5A-5C are exemplary views illustrating still another example OSD;

FIG. 6 is an exemplary block diagram for describing a configuration in which the video apparatus according to the embodiment is applied to a television receiver; and

FIG. 7 is an exemplary block diagram for describing another configuration in which the video apparatus according to the embodiment is applied to a television receiver.

### DETAILED DESCRIPTION

Various embodiments according to the invention will be described hereinafter with reference to the accompanying drawings.

### First Embodiment

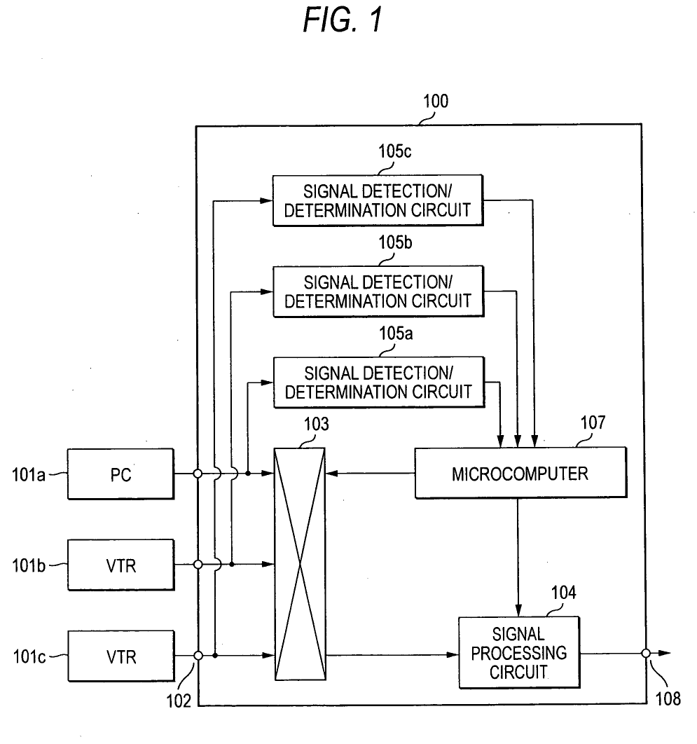

FIG. 1 is a view showing a configuration of a video apparatus according to a first embodiment.

As shown in FIG. 1, the video apparatus 100 includes an input terminal 102, a selector 103, a signal processing circuit 104, signal detection/determination circuits 105a-105c, a microcomputer 107, and an output terminal 108. In a case where the video apparatus is a projector, optical components are further provided; and when the same is a television receiver, a tuner, or the like, is further provided.

External video devices 101a-101c are video apparatuses for supplying video signals from the outside to the video apparatus 100 of the invention. In the first embodiment, the external video device 101a is a personal computer; and the external video devices 101b and 101c are video tape recorders. Meanwhile, each of the external video devices 101b-101c may be either a playback-only apparatus or a disc recorder. The external video devices 101a-101c supply video signals to the input terminal 102 under operating conditions with power-up.

The signal detection/determination circuit 105a determines a format of a video signal being input from the external video device 101a, and outputs a result of the determination to the microcomputer 107.

The signal detection/determination circuit 105b determines a format of a video signal being input from the external video device 101b, and outputs a result of the determination to the microcomputer 107.

The signal detection/determination circuit 105c determines a format of a video signal being input from the external video device 10c, and outputs a result of the determination to the microcomputer 107.

Thus, the signal detection/determination circuits 105a-105c determine formats of video signals input to each of the input terminals at all times, and the result of the determination is supplied to the microcomputer 107. According to this configuration, the microcomputer 107 can grasp input statuses pertaining to the input terminals at all times.

When a new video signal is input from any one of the external video devices 101a-101c in a state where no video signal is being input from the external video devices 101a-101c, the microcomputer 107 receives from the signal detection/determination circuit 105 an input of a result of a format determination pertaining to the thus-input video signal. Upon receipt of this result, the microcomputer 107 outputs to the selector 103 a control signal for selecting the external video device 101, from which the video signal has been newly supplied.

The selector 103 selects that video signal output from the one of the external video devices 101a-101c in accordance with the control signal supplied from the microcomputer 107, and outputs the video signal to the signal processing circuit 104.

The signal processing circuit 104 performs, on the video signal input from the selector 103, processing in accordance with the control signal output from the microcomputer 107, OSD (On Screen Display) processing, and the like; and thereafter outputs to the output terminal 108 the thus-processed video signal. Examples of the above processing in accordance with a control signal include processing for, when, e.g., an NTSC signal, a PAL/SECAM signal, or a like signal is input in accordance with a broadcast system, converting the signal into a signal of a type required by an external display device. Other examples of the processing in accordance with a control signal include: image correction processing, interface conversion processing, and the like. The video signal supplied to the output terminal 108 from the signal processing circuit 104 is output to an external display device.

As a result, upon input of a new video signal from any one of the external video devices 101a-101c in a state where no video signal is being input from the external video devices 101a-101c, a video signal output from the external video device 101—from which the new video signal is input—is selected by the selector 103; and the thus-input video signal is subjected to signal processing in accordance with a type of the signal, to thereby be output from the output terminal 108.

According to the configuration described above, search of an input terminal can be performed in parallel, thereby shortening the time that elapses before output of an image.

### Second Embodiment

Next, a second embodiment will be described in detail.

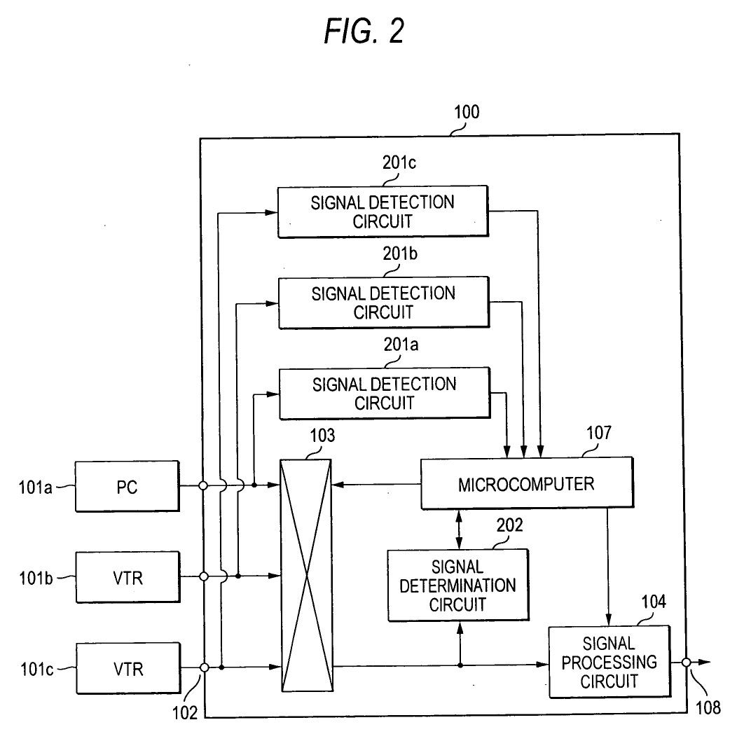

FIG. 2 is a view showing the configuration of a video apparatus according to the second embodiment. The second embodiment differs from the first embodiment in that a circuit for determining a signal is used in a shared manner.

As shown in FIG. 2, a video apparatus 100 includes the input terminal 102, the selector 103, the signal processing circuit 104, signal detection circuits 201a-201c, a signal determination circuit 202, the microcomputer 107, and the output terminal 108. When the video apparatus is a projector, optical components are further provided; and when the same is a television receiver, a tuner, or the like, is further provided.

The external video devices 101a-101c are video apparatuses for supplying to the video apparatus 100 of the invention video signals from the outside. In the second embodiment, the external video device 101a is a personal computer; and the external video devices 101b and 101c are video tape recorders. Meanwhile, each of the external video devices 101b and 101c may be either a playback-only apparatus or a disc recorder. The external video devices 101a-101c supply video signals to the input terminal 102 under operating conditions with power-up.

The signal detection circuit 201a determines whether or not a video signal is being input from the external video device 101a, and outputs a result of the determination to the microcomputer 107.

The signal detection circuit 201b determines whether or not a video signal is being input from the external video device 101b, and outputs a result of the determination to the microcomputer 107.

The signal detection circuit 201c determines whether or not a video signal is being input from the external video device 101c, and outputs a result of the determination to the microcomputer 107.

Upon input of a video signal from the selector 103, the signal determination circuit 202 determines a format of the video signal, and outputs a result of the determination to the microcomputer 107.

Thus, the microcomputer 107 ascertains connection conditions of all of the input terminals by means of the signal detection circuits 201a-201c at all times. When a new video signal is input from any one of the external video devices 101a-101c in a state where no video signal is being input from the external video devices 101a-101c, the microcomputer 107 causes the selector 103 to select a video signal output from the external video device 101 from which the newly-input video signal is supplied.

The signal determination circuit 202 determines a format of the newly-input video signal, and outputs a result of the determination to the microcomputer 107.

According to the above configuration, the microcomputer 107 can grasp input statuses pertaining to the input terminals.

When a new video signal is input from any one of the external video devices 101a-101c in a state where no video signal is being input from the external video devices 101a-101c, the microcomputer 107 detects this input on the basis of a result of determination input from the signal detection circuit 201. Accordingly, the microcomputer 107 outputs to the selector 103 a control signal for selecting the external video device 101 from which the video signal is newly supplied. Furthermore, the microcomputer 107 outputs to the signal determination circuit 202 a control signal for determining a format of the video signal.

The selector 103 selects a video signal output from one of the external video devices 101a-101c in accordance with the control signal supplied from the microcomputer 107, and outputs the video signal to the signal processing circuit 104 and to the signal determination circuit 202.

The signal determination circuit 202 is controlled by the control signal output from the microcomputer 107, and determines a format of the video signal selected by the selector 103, and outputs a result of the determination to the microcomputer 107.

The signal processing circuit 104 performs, on the video signal input from the selector 103, processing in accordance with the control signal output from the microcomputer 107, OSD processing, and the like; and thereafter outputs to the output terminal 108 the thus-processed video signal. Examples of the above processing in accordance with a control signal include processing for, when an NTSC signal, a PAL/SECAM signal, or a like signal is input in accordance with a broadcast system, converting a signal into a signal of a type required by an external display device. Other examples of the processing in accordance with a control signal include: video correction processing, interface conversion processing, and the like. The video signal supplied to the output terminal 108 from the signal processing circuit 104 is output to an external display device.

As a result, upon input of a new video signal from any one of the external video devices 101a-101c in a state where no video signal is being input from the external video devices 101a-101c, a video signal output from the external video device 101—from which the new video signal is input—is selected by the selector 103; and the thus-input video signal is subjected to signal processing in accordance with a type of the signal, to thereby be output from the output terminal 108.

According to the configuration described above, search of an input terminal can be performed in parallel, thereby shortening the time that elapses before output of an image.

### Third Embodiment

Next, a third embodiment will be described in detail.

The third embodiment is a modified embodiment of the previously-described first embodiment or second embodiment.

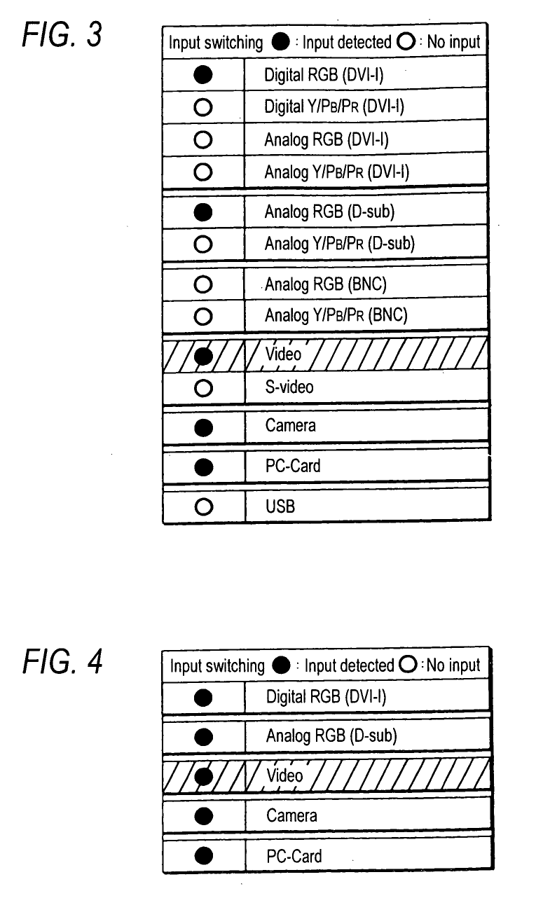

The signal processing circuit 104 has an OSD (On Screen Display) function. The microcomputer 107 controls the signal processing circuit 104 so that the signal processing circuit 104 superimposes a display; e.g., an input menu, such as that shown in FIG. 3, into the video signal input from the selector 103 by use of the OSD function. The input menu is a display for ascertaining input statuses and indicates the input terminal 102—from the plurality of input terminals 102—from which video signals are being input.

FIG. 3 shows an example where the above is applied to input signal switching. The microcomputer 107 causes display of a solid circle indicating an input terminal to which a video signal is being input, and an outlined circle indicating an input terminal to which no video signal is being input. In the drawing, video signals are being input from five input terminals, constituted of a digital RGB (DVI-I) input terminal, an analog RGB (D-sub) input terminal, a video input terminal, a camera input terminal, and a PC-card input terminal; and the video input terminal is highlighted with a hatched pattern. Accordingly, the drawing indicates that a video signal input from the video input terminal is currently being output from the output terminal 108. Meanwhile, the example shown in FIG. 3 indicates an example where the number of input terminals is greater than that in each example shown in FIGS. 1 and 2.

A command from a user is transmitted to the microcomputer 107 by means of, e.g., pressing an up-down button, with use of an unillustrated remote controller, or the like; whereupon the microcomputer 107 performs input switching. When the up-down button is pressed in order to make the selection, the microcomputer 107 switches to a closest input terminal.

In this example, input switching is performed by means of pressing the up-down button. Alternatively, there may be adopted another configuration where input terminals—to which video signals are input—are sequentially switched by means of pressing, e.g., an “input switching” button. In this case, the microcomputer 107 may be configured so as, when no video signal is input to the other input terminals, to display a message notifying the user that no video signal is input to the other input terminals.

The above control operations are performed in accordance with programs stored in the microcomputer 107.

As a result, a user can ascertain input terminals to which video signals are currently being input.

Thus, terminals which are not connected are eliminated from the available choices. Accordingly, when a user selects connection terminals in a state where a plurality of input terminals are connected, this selection is facilitated.

### Fourth Embodiment

Next, a fourth embodiment will be described in detail.

In the fourth embodiment, input can be selected from only input terminals via which signals have been input through use of automatic input and search. In the third embodiment, all the input terminals are displayed. In contrast, in the present embodiment, the microcomputer 107 provides, for input selection, a display of only input terminals to which video signals are being input.

As a result, a user can perform input switching from a menu whose available choices are only input terminals to which video signals are being input.

There may also be adopted another configuration in which the third embodiment and the fourth embodiment can be switched by means of switching a setting of the microcomputer 107. In such a case, switching between operations in accordance with the embodiments is performed by means of, e.g., storing the setting of the microcomputer 107 in non-volatile memory or a register in the microcomputer 107.

### Modifications of the Embodiments

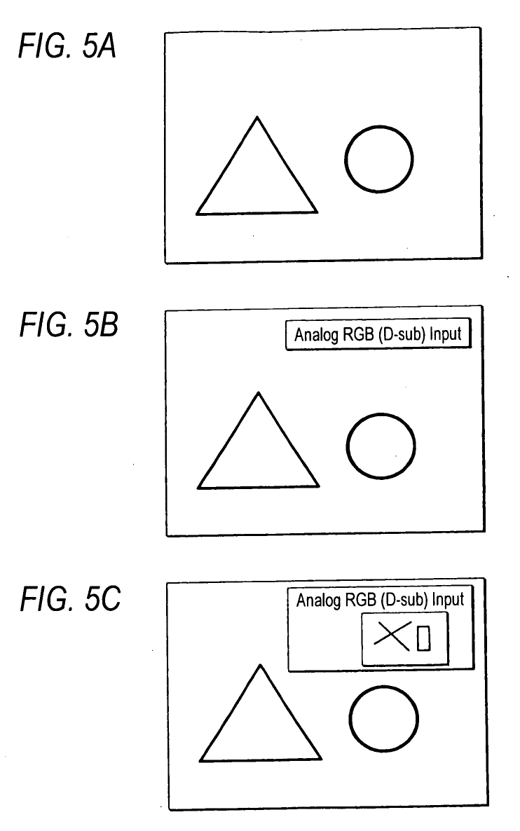

As a modification, upon detection of a new input signal, the microcomputer 107 may display the terminal to which the new signal is input, by means of superimposing the input signal into a video signal currently being output from the output terminal 108 as illustrated in FIGS. 5A-5C. FIGS. 5A-5C are examples showing that a new video signal has been input from a USB input terminal. When an input is newly made from the USB input terminal in the state illustrated in FIG. 5A, the display shown in FIG. 5B is displayed via OSD.

In this example, the video signal is superimposed in the form of character information. However, the invention is not limited thereto, and the video signal may also be in the form of an image such as an icon.

Furthermore, when there is imparted a function of supplying to the signal processing circuit 104 signals from a plurality of input terminals, and superimposing the same; and the obtained result is displayed in the form of multi-screen, such as PIP (picture-in-picture) as illustrated in FIG. 5C, a user can also ascertain what type of video signal has been input.

In a case where a display is an SED (surface-conduction electron-emitter display), a CRT (cathode ray tube) display, a plasma display, or the like, projection of a static image on the display for a long period of time is likely to cause screen burn-in. Therefore, after OSD has continued for a predetermined period of time (e.g., ten seconds), the microcomputer 107 terminates the OSD. According to this configuration, screen burn-in can be prevented.

According to this configuration, a terminal to which a new video signal is input can be ascertained. In addition, screen burn-in can be prevented.

The present invention can also be applied to: (1) a DMD (digital micro-mirror device) in which 0.48 to 1.31 million micro-mirrors of micron size are laid all over a semiconductor; (2) an LCD (liquid crystal display) which is configured such that a material of a crystalline state is sealed between two glass plates, and in which the orientations of liquid crystal molecules are changed by means of applying a voltage to the material, to thus increase/decrease the transmittance of light, thereby displaying an image; (3) an SED (surface-conduction electron-emitter display) which is one type of an FED (surface emission display) and which utilizes a display element; a so-called surface-conduction electron-emitter; (4) a plasma display panel which is configured such that a high-pressure gas such as helium, neon, or the like is sealed between two glass members, and in which a voltage is applied thereto so as to cause the gas to emit light; (5) a CRT (cathode ray tube) in which an electronic beam, emitted from an electron gun, is steered by electromagnets—a so-called deflecting yoke—disposed on a lateral face, thereby irradiating a phosphor film on the front face of the apparatus, to thus cause emission of light; or (6) a data projector or a television receiver—each of which includes use of an electro-luminescent display—in which a phosphor material receives energy from an electric field serving as an excitation source, and releases the energy in the form of light emission.

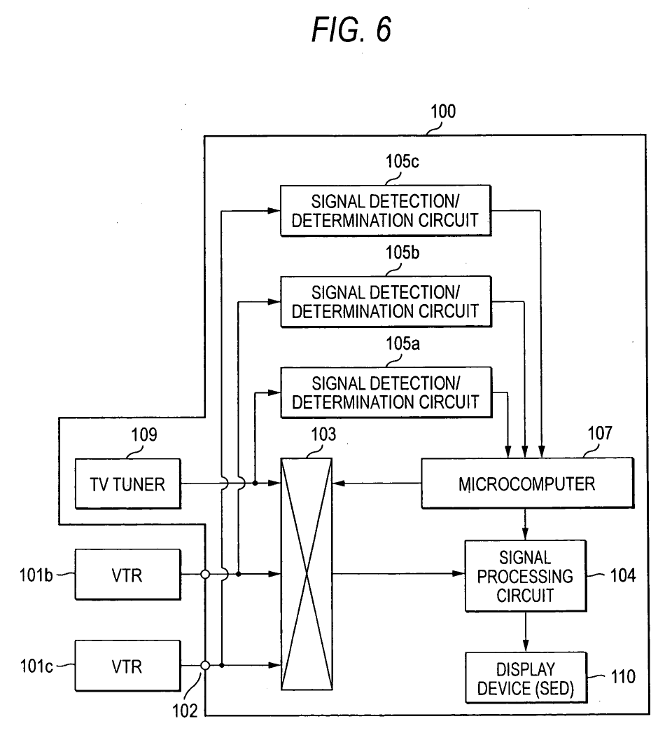

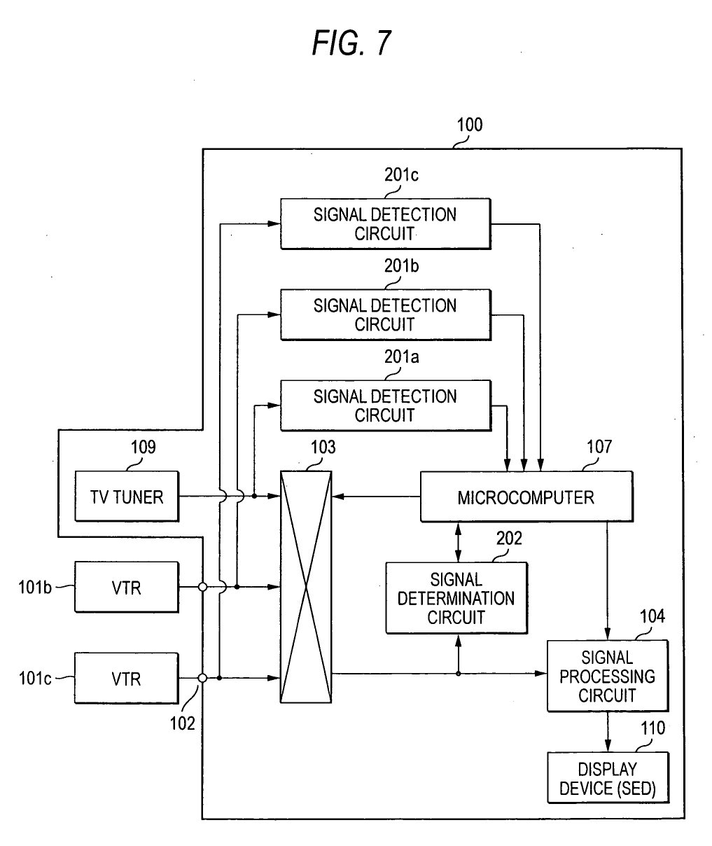

FIGS. 6 and 7 are views illustrating example configurations in each of which the present invention is applied to a television receiver including one of the above-mentioned displays.

FIG. 6 shows an example configuration in which the present invention is applied to a television receiver. FIG. 7 shows an example configuration in which the configuration shown in FIG. 2 is applied to a television receiver. Each of the configurations shown in FIGS. 6 and 7 differs from that shown in FIG. 1 or 2 in incorporating a tuner 109, as well as having a display 110 for displaying a signal which has been subjected to signal processing by the signal processing circuit 104.

Similar advantages can also be yielded when the present invention is applied to the above television receivers.

As described above in detail with respect to the embodiments, according to the present invention, whether or not signals are supplied to a plurality of input terminals is detected by a plurality of input signal detection circuits. Therefore, there can be provided a video apparatus which can detect signals without consuming much time.

It is to be understood that the present invention is not limited to the specific embodiments described above and that the present invention can be embodied with the components modified without departing from the spirit and scope of the invention. The present invention can be embodied in various forms according to appropriate combinations of the components disclosed in the embodiments described above. For example, some components may be deleted from all components shown in the embodiment. Further, the components in different embodiments may be used appropriately in combination.

What is claimed is:

1. A video apparatus comprising:
a video output terminal;
a selector that is provided with a plurality of video input terminals, and selects one of the video input terminals to output a video signal input to the selected video input terminal;
a plurality of video signal detection units that are provided for the respective video input terminals, each of the video signal detection units determining whether or not a video signal is input to the respective video input terminals;
a plurality of signal determination units that are provided for the respective video signal detection units, each of the signal determination units determining a format of the video signal that is input to the respective video input terminals, when the respective video signal detection units detects that the video signal is input to the respective video input terminals;
a signal processing unit that performs signal processing on the video signal output by the selector in accordance with determination results of the signal determination units; and
a controller that, when a video signal is newly detected by at lest one of the video signal detection units during a period in which no video signal is input to the video input terminals, supplies to the signal processing unit the determination result of the signal determination unit corresponding to the video signal detection unit that detected the new video signal, and controls the selector to select the video input terminal in which the new video signal is input to output the new video signal to the video output terminal.

2. The video apparatus according to claim 1, wherein the signal processing section includes an OSD processing unit that superimposes an image onto an image that is to be displayed by the video signal, and
wherein the controller controls, when the new video signal is detected by at least one of the video signal detection units, the OSD processing unit to generate an image that notifies the detection of the new video signal and to superimpose the generated image onto the image that is displayed by the video signal.

3. The video apparatus according to claim 2, wherein the controller controls the OSD processing unit to generate the image to be superimposed, the image including at least one of a name of the input terminal to which the new video signal is input, and a video image provided by the new video signal.

4. The video apparatus according to claim 3, wherein the controller controls the signal processing unit to terminate the superimposing operation.

5. A video apparatus comprising:
a video output terminal;
a selector that is provided with a plurality of video input terminals, and selects one of the video input terminals to output a video signal input to the selected video input terminal;
a plurality of video signal detection units that are provided for the respective video input terminals, each of the video signal detection units determining whether or not a video signal is input to the respective video input terminals;
a signal determination unit that determines a format of the video signal that is output from the selector;
a signal processing unit that performs signal processing on the video signal output by the selector in accordance with determination results of the signal determination unit; and
a controller that, when a video signal is newly detected by at lest one of the video signal detection units during a period in which no video signal is input to the video input terminals, controls the selector to select the video input terminal in which the new video signal is input to output the new video signal to the video output terminal.

6. The video apparatus according to claim 5, wherein the signal processing section includes an OSD processing unit that superimposes an image onto an image that is to be displayed by the video signal, and
wherein the controller controls, when the new video signal is detected by at least one of the video signal detection units, the OSD processing unit to generate an image that notifies the detection of the new video signal and to superimpose the generated image onto the image that is displayed by the video signal.

7. The video apparatus according to claim 6, wherein the controller controls the OSD processing unit to generate the image to be superimposed, the image including at least one of a name of the input terminal to which the new video signal is input, and a video image provided by the new video signal.

8. The video apparatus according to claim 7, wherein the controller controls the signal processing unit to terminate the superimposing operation.

9. A method for selecting a video signal in a video apparatus having a plurality of video input terminals, the method comprising:
determining whether or not video signals are input to the respective video input terminals by a plurality of video signal detection units that are provided for the respective video input terminals;
determining a format of each of the video signals that are input to the respective video input terminals by a plurality of signal determination units that are provided for the respective video signal detection units;
selecting one of the video input terminals by a selector to output a video signal input to the selected video input terminal;
performing signal processing on the selected video signal by a signal processing unit in accordance with the determination results by the signal determination units; and
controlling, when a video signal is newly detected by at lest one of the video signal detection units during a period in which no video signal is input to the video input terminals, to supply to the signal processing unit the determination result of the signal determination unit corresponding to the video signal detection unit that detected the new video signal, to control the selector to select the video input terminal in which the new video signal is input to output the new video signal to a video output terminal.

10. The method according to claim 9, further comprising:
superimposing an image by an OSD processing unit provided in the signal processing unit onto an image that is to be displayed by the video signal; and
controlling, when the new video signal is detected by at least one of the video signal detection units, the OSD processing unit to generate an image that notifies the detection of the new video signal and to superimpose the generated image onto the image that is displayed by the video signal.

11. The method according to claim 10, further comprising controlling the OSD processing unit to generate the image to be superimposed, the image including at least one of a name of the input terminal to which the new video signal is input, and a video image provided by the new video signal.

12. The method according to claim 11, further comprising controlling the signal processing unit to terminate the superimposing operation.
